(19) United States
(12) Patent Application Publication
(10) Pub. No.: US 2024/0072269 A1
(43) Pub. Date: Feb. 29, 2024

(54) FUEL CELL

(71) Applicant: HONDA MOTOR CO., LTD., Tokyo (JP)

(72) Inventors: Kotaro HORIAI, WAKO-SHI (JP); Takehiro MUGISHIMA, WAKO-SHI (JP); Hitoshi NAGASAKI, WAKO-SHI (JP)

(21) Appl. No.: 18/230,874

(22) Filed: Aug. 7, 2023

(30) Foreign Application Priority Data
Aug. 24, 2022 (JP) 2022-133389

(51) Int. Cl. H01M 8/0256; H01M 8/1004

(52) U.S. Cl. CPC H01M 8/0256; H01M 8/1004

(57) ABSTRACT

The fuel cell includes a first separator electrically insulated from an anode, a first conductive member connected to the anode and passing through the first separator while being electrically insulated from the first separator, a second separator electrically insulated from the cathode, and a second conductive member connected to the cathode and passing through the second separator while being electrically insulated from the second separator.

### CROSS-REFERENCE TO RELATED APPLICATIONS

This application is based upon and claims the benefit of priority from Japanese Patent Application No. 2022-133389 filed on Aug. 24, 2022, the contents of which are incorporated herein by reference.

### BACKGROUND OF THE INVENTION

### Field of the Invention

The present invention relates to a fuel cell.

### Description of the Related Art

In recent years, research and development have been conducted on fuel cell that contribute to energy efficiency in order to ensure that more people have access to affordable, reliable, sustainable and modern energy. Further, in order to reduce the burden on the global environment, the vehicle emissions control has been more stringent. For this reason, attempts have been made to mount fuel cells instead of an internal combustion engine in a moving object such as an automobile. Because CO₂, SOₓ, NOₓ, and the like are not discharged from the moving object on which the fuel cells are mounted, the burden on the global environment can be reduced.

A fuel cell generates electric power through electrochemical reactions between a fuel gas and an oxygen-containing gas. As a fuel cell, there is known a planar array type fuel cell in which a plurality of cell blocks are arranged in a plane direction of one electrolyte membrane (see WO 2017/047342 A1).

In the planar array type fuel cell, the plurality of cell blocks are connected in series by interconnector parts formed in the electrolyte membrane. Therefore, the planar array type fuel cell has advantages of generating high-voltage power with one electrolyte membrane.

### SUMMARY OF THE INVENTION

In the planar array type fuel cell, the anode facing one surface of the electrolyte membrane is divided into a plurality of anode portions. In order to prevent short circuits between the anode portions, the surface of the anode opposite to the surface facing the electrolyte membrane faces a surface of a metal separator coated with an insulating member. Similarly, the cathode facing the other surface of the electrolyte membrane is divided into a plurality of cathode portions. In order to prevent short circuits between the cathode portions, the surface of the cathode opposite to the surface facing the electrolyte membrane faces a surface of a metal separator coated with an insulating member. The metal separators are used as conductors for collecting the generated electric power in many cases.

However, when the metal separators are used as conductors for collecting electric power generated by the fuel cell, there is a concern that the insulating members may be broken. Therefore, it has been a problem of stable collecting of generated electric power.

An object of the present invention is to solve the aforementioned problem.

According to an aspect of the present invention, there is provided a fuel cell including an anode divided into a plurality of anode portions, a cathode divided into a plurality of cathode portions, an electrolyte membrane arranged between the anode and the cathode, the electrolyte membrane being provide with a plurality of interconnectors, one of the interconnectors connecting one of the anode portions and one of the cathode portions, a first separator electrically insulated from the anode and facing a surface of the anode that is opposite to a surface of the anode facing the electrolyte membrane, a first conductive member connected to the anode, passing through the first separator while being electrically insulated from the first separator, and exposed on a surface of the first separator other than a surface facing the anode, a second separator electrically insulated from the cathode and facing a surface of the cathode that is opposite to a surface of the cathode facing the electrolyte membrane, and a second conductive member connected to the cathode, passing through the second separator while being electrically insulated from the second separator, and exposed on a surface of the second separator other than a surface facing the cathode.

According to the aspect of the present invention, the first separator and the second separator are in an electrically floating state. Therefore, even if water reaches the second separator (or the first separator) formed of metal, corrosion of the second separator (or the first separator) due to water-mediated electrochemical reactions can be suppressed. As a result, dielectric breakdown of the insulating film members of the first separator electrically insulated from the anode and the second separator electrically insulated from the cathode is suppressed, and generated electric power can be stably output.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a partial cross-sectional view of a fuel cell; and

FIG. 2 is a partial cross-sectional view of a fuel cell of a comparative example.

### DETAILED DESCRIPTION OF THE INVENTION

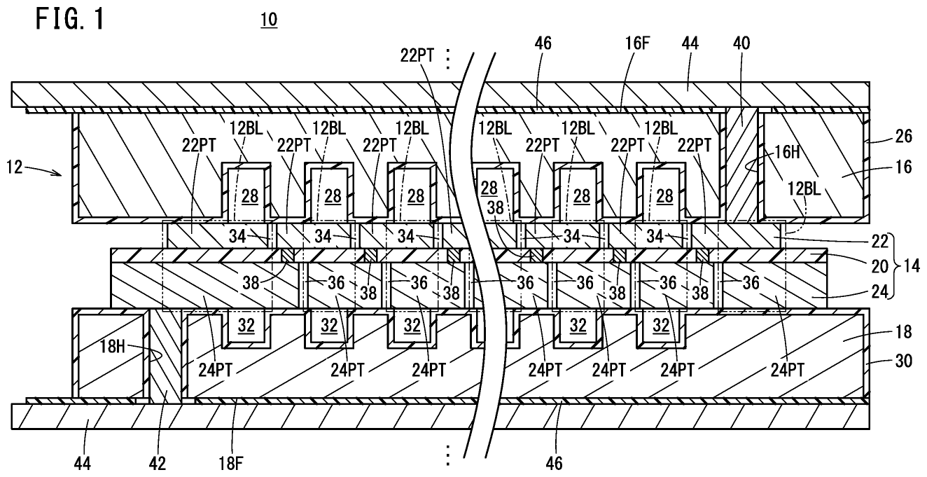

FIG. 1 is a partial cross-sectional view of a fuel cell 10. The fuel cell 10 generates electric power through electrochemical reactions between a fuel gas and an oxygen-containing gas. The fuel gas is a gas containing hydrogen. The oxygen-containing gas is a gas containing oxygen. The oxygen-containing gas may be air. In the fuel cell 10, a plurality of unit cells 12 are stacked. Each unit cell 12 has an equivalent structure. In FIG. 1, one of the plurality of unit cells 12 is shown.

The unit cell 12 includes a membrane electrode assembly 14, a first separator 16, and a second separator 18. The membrane electrode assembly 14 may be referred to as an MEA. The membrane electrode assembly 14 includes an electrolyte membrane 20, an anode 22, and a cathode 24. The membrane electrode assembly 14 is disposed between the first separator 16 and the second separator 18.

The anode 22 includes a first surface facing the electrolyte membrane 20 and a second surface opposite to the first surface and facing the first separator 16. The first separator 16 is formed of metal. At least a surface of the first separator 16 facing the anode 22 is covered with a first insulating film member 26. In the present embodiment, surfaces of the first separator 16 other than a first surface 16F are covered with the first insulating film member 26. The first surface 16F of the first separator 16 is a surface opposite to the surface of the first separator 16 facing the anode 22. A plurality of fuel gas channels 28 are formed on the surface of the first separator 16 facing the anode 22. The plurality of fuel gas channels 28 extend at intervals in the planar direction of the first separator 16.

The cathode 24 includes a first surface facing the electrolyte membrane 20 and a second surface opposite to the first surface and facing the second separator 18. The second separator 18 is formed of metal. At least a surface of the second separator 18 facing the cathode 24 is covered with the second insulating film member 30. In the present embodiment, surfaces of the second separator 18 other than a second surface 18F are covered with the second insulating film member 30. The second surface 18F of the second separator 18 is a surface opposite to the surface of the second separator 18 facing the cathode 24. A plurality of oxygen-containing gas channels 32 are formed on the surface of the second separator 18 facing the cathode 24. The oxygen-containing gas channels 32 extend at intervals in the planar direction of the second separator 18.

For example, the electrolyte membrane 20 is a solid polymer electrolyte membrane (cation exchange membrane) such as a thin membrane of perfluorosulfonic acid containing water. The electrolyte membrane 20 may be a fluorine-based electrolyte membrane or a hydrocarbon (HC)-based electrolyte membrane. The electrolyte membrane 20 is sandwiched between the anode 22 and the cathode 24.

The anode 22 is provided on one surface of the electrolyte membrane 20. The anode 22 may include an anode catalyst layer and a gas diffusion layer. The anode catalyst layer is a layer containing a catalyst for oxidation reactions of hydrogen in the fuel gas. The anode catalyst layer is joined to one surface of the electrolyte membrane 20. The gas diffusion layer is a layer for diffusing the fuel gas supplied from the fuel gas channels 28 and letting the fuel gas flow to the anode catalyst layer. The gas diffusion layer is joined to a surface of the catalyst layer opposite to a surface of the anode catalyst layer facing the electrolyte membrane 20.

The cathode 24 is provided on the other surface of the electrolyte membrane 20. The cathode 24 may include a cathode catalyst layer and a gas diffusion layer. The cathode catalyst layer is a layer containing a catalyst for the reduction reactions of oxygen. The cathode catalyst layer is joined to the other surface of the electrolyte membrane 20. The gas diffusion layer is a layer for diffusing the oxygen-containing gas supplied from the oxygen-containing gas channels 32 and letting the oxygen-containing gas flow to the cathode catalyst layer. The gas diffusion layer is joined to a surface of the catalyst layer opposite to a surface of the cathode catalyst layer facing the electrolyte membrane 20.

The anode catalyst layer and the cathode catalyst layer may contain carbon particles on which catalyst metal is supported. Examples of the catalyst metal include metals such as platinum, ruthenium, iridium, rhodium, palladium, osmium, tungsten, lead, iron, chromium, cobalt, nickel, manganese, vanadium, molybdenum, gallium, and aluminum. Two or more metals may be combined. The anode catalyst layer and the cathode catalyst layer may have porous structure in order to increase contact areas with the respective gases. The gas diffusion layers may comprise carbon particles. The gas diffusion layers may have porous structure in order to efficiently diffuse the respective gases.

In the present embodiment, a plurality of cell blocks 12BL are formed in the unit cell 12. In FIG. 1, some of the cell blocks 12BL are respectively surrounded by broken lines for easy understanding. Each cell block 12BL includes, as components, one anode portion 22PT, one cathode portion 24PT, and an electrolytic membrane 20 arranged between the anode and cathode portions.

The anode portion 22PT is a part of the anode 22. The anode portion 22PT is formed by dividing grooves 34. That is, the dividing grooves 34 divide the anode 22 into a plurality of anode portions 22PT. The dividing grooves 34 extend from one edge to the opposite edge of the anode 22 along the fuel gas channels 28. The anode portion 22PT may have, in planar view, a rectangular shape having long sides in the extending direction of the dividing grooves 34 and short sides as the interval between two adjacent dividing grooves 34.

The cathode portion 24PT is a part of the cathode 24. The cathode portion 24PT is formed by dividing grooves 36. That is, the dividing grooves 36 divide the cathode 24 into a plurality of cathode portions 24PT. The dividing grooves 36 extend from one edge to the opposite edge of the cathode 24 along the oxygen-containing gas channels 32. The cathode portion 24PT may have, in planar view, a rectangular shape having long sides in the extending direction of the dividing grooves 36 and short sides as the interval between the two adjacent dividing grooves 36.

The plurality of cell blocks 12BL are connected in series by interconnectors 38. The interconnectors 38 electrically connect the anode portions 22PT to the cathode portions 24PT. In this case, the interconnector 38 connects the anode portion 22PT of one of the two adjacent cell blocks 12BL to the cathode portion 24PT of the other of the two adjacent cell blocks 12BL. The interconnectors 38 are formed in the electrolyte membrane 20. The interconnectors 38 are formed by, for example, locally heating the electrolyte membrane 20 to cause local carbonization. The interconnectors 38 may be conductive carbides derived from a proton conductive resin. Examples of the proton conductive resin include aromatic polymer compounds such as aromatic poly(arylene ether ketones), aromatic poly(arylene ether sulfones) obtained by introducing at least one sulfonic acid group into a hydrocarbon polymer and the like.

In the present embodiment, the fuel cell 10 further includes a first conductive member 40, a second conductive member 42, and a plurality of electrode tabs 44.

The first conductive member 40 and the second conductive member 42 are members having conductivity. The first conductive member 40 and the second conductive member 42 are formed of, for example, graphite.

The first conductive member 40 is connected to the anode 22. In this case, the first conductive member 40 is connected to one of the plurality of anode portions 22PT constituting the anode 22. Among the plurality of cell blocks 12BL connected in series, the first conductive member 40 is connected to the anode portion 22PT of the cell block 12BL positioned at the far end from a power output port.

The first conductive member 40 passes through the first separator 16 while being electrically insulated from the first separator 16, and is exposed on the first surface 16F of the first separator 16. In this case, the first conductive member 40 passes through a through-hole 16H of the first separator 16. The through-hole 16H extends in the thickness-wise direction of the first separator 16 and is open to both the first surface 16F and the surface opposite to the first surface 16F of the first separator 16. The inner surface of the through-hole 16H is covered with the first insulating film member 26.

The second conductive member 42 is connected to the cathode 24. In this case, the second conductive member 42 is connected to one of the plurality of cathode portions 24PT constituting the cathode 24. Among the plurality of cell blocks 12BL connected in series, the second conductive member 42 is connected to the cathode portion 24PT of the cell block 12BL positioned at the nearest end from the output port. The cathode portion 24PT to which the second conductive member 42 is connected may be the cathode portion 24PT of the cell block 12BL positioned at the far end. In this case, the anode portion 22PT to which the first conductive member 40 is connected is the anode portion 22PT of the cell block 12BL positioned at the nearest end.

The second conductive member 42 passes through the second separator 18 while being electrically insulated from the second separator 18, and is exposed on the second surface 18F of the second separator 18. In this case, the second conductive member 42 passes through a through-hole 18H of the second separator 18. The through-hole 18H extends in the thickness-wise direction of the second separator 18 and open on both the second surface 18F and the surface opposite to the second surface 18F of the second separator 18. The inner surface of the through-hole 18H is covered with the second insulating film member 30.

The electrode tab 44 is a conductor for collecting power generated at the unit cells 12. The electrode tab 44 may be a metal plate. One of the plurality of electrode tabs 44 is joined to the first surface 16F of the first separator 16 by a joining member 46 in a state of electrical and mechanical connection with the first conductive member 40. Another of the plurality of electrode tabs 44 is joined to the second surface 18F of the second separator 18 by another joining member 46 in a state of electrical and mechanical connection with the second conductive member 42. The joining member 46 may be an adhesive that has sealing properties.

The electrode tabs 44 are alternately stacked with the unit cells 12. That is, the fuel cell 10 of the present embodiment has a layer structure in which the layer of the electrode tab 44 and the layer of the unit cell 12 are repeatedly stacked.

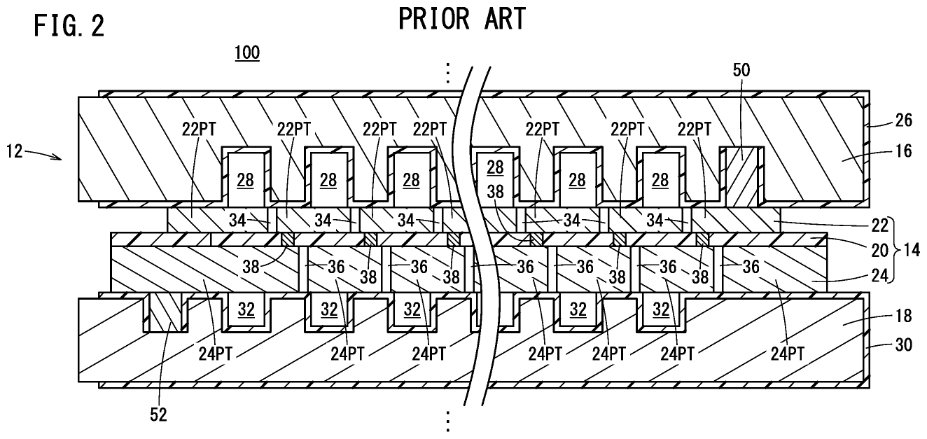

FIG. 2 is a partial cross-sectional view of a fuel cell 100 of a comparative example. In FIG. 2, the same reference numerals are assigned to the same constituent elements as those described in the embodiment. In the fuel cell 100 of the comparative example, the first separator 16 and the second separator 18 function as conductors for collecting the generated electric power.

That is, in the fuel cell 100 of the comparative example, the electrode tabs 44 are omitted. Substantially the entire surface of the first separator 16 is covered with the first insulating film member 26, and substantially the entire surface of the second separator 18 is covered with the second insulating film member 30. Furthermore, a first conductive member 50 is provided instead of the first conductive member 40, and a second conductive member 52 is provided instead of the second conductive member 42.

The first conductive member 50 electrically connects the first separator 16 to the anode 22. A part of the first conductive member 50 is fitted into a recess in the first separator 16, and another part of the first conductive member 50 is connected to the anode portion 22PT at the far end. The second conductive member 52 electrically connects the second separator 18 to the cathode 24. A part of the second conductive member 52 is fitted into a recess in the second separator 18, and another part of the second conductive member 52 is connected to the cathode portion 24PT at the near end.

In the fuel cell 100 of the comparative example, the second insulating film member 30 may be broken. That is, if there is a tiny crack on the first insulating film member 26 or the second insulating film member 30, water contained in the fuel gas or the oxygen-containing gas tends to penetrate into the crack. Once the water reaches the second separator 18, because the second separator 18 is electrically connected to the cathode 24 as the positive electrode, the second separator 18 formed of metal corrodes due to water-mediated electrochemical reactions. For example, in a case where the second separator 18 is formed of copper, the copper is ionized, eluted, and corroded. Then, the conductivity of water increases, and eventually sparks fly. As a result, the second insulating film member 30 is broken.

In contrast, in the fuel cell 10 of the present embodiment, the first separator 16 is electrically insulated from the anode 22. Instead, the first conductive member 40 electrically connected to the anode 22 passes through the first separator 16 while being electrically insulated from the first separator 16, and is connected to the electrode tab 44 disposed outside the first separator 16. Similarly, the second separator 18 is electrically insulated from the cathode 24. Instead, the second conductive member 42 electrically connected to the cathode 24 passes through the second separator 18 while being electrically insulated from the second separator 18, and is connected to the electrode tab 44 disposed outside the second separator 18.

That is, in the fuel cell 10 of the present embodiment, the first separator 16 and the second separator 18 are in an electrically floating state. Therefore, even if water reaches the second separator 18 (or the first separator 16) formed of metal, corrosion of the second separator 18 (or the first separator 16) due to water-mediated electrochemical reactions can be suppressed. As a result, breakdown of the first insulating film member 26 and the second insulating film member 30 is suppressed, and the generated power can be stably collected.

The above-described embodiment may be modified, for example, in the following manner.

The surface of the first separator 16 on which the first conductive member 40 is exposed is not limited to the first surface 16F, and may be any surface of the first separator 16 other than the surface facing the anode 22. In this case, the electrode tab 44 may be omitted. Alternatively, instead of the electrode tab 44, a conductive wire covered with an insulating film may be connected to the first conductive member 40.

Similarly, the surface of the second separator 18 on which the second conductive member 42 is exposed is not limited to the second surface 18F, and may be any surface of the second separator 18 other than the surface facing the cathode 24. In this case, the electrode tab 44 may be omitted. Alternatively, instead of the electrode tab 44, a conductive wire covered with an insulating film may be connected to the second conductive member 42.

The invention grasped based on the above is described below.

(1) The fuel cell (10) according to the present invention includes the anode (22) divided into the plurality of anode portions (22PT), the cathode (24) divided into the plurality of cathode portions (24PT), the electrolyte membrane (20) arranged between the anode (22) and the cathode (24), the electrolyte membrane (20) being provided with the plurality of interconnectors (38), one of the interconnectors (38) connecting one of the anode portions (22PT) and one of the cathode portions (24PT), the first separator (16) electrically insulated from the anode (22) and facing the surface of the anode (22) that is opposite to the surface of the anode (22) facing the electrolyte membrane (20), the first conductive member (40) connected to the anode (22), passing through the first separator (16) while being electrically insulated from the first separator (16), and exposed on the surface of the first separator (16) other than the surface facing the anode (22), the second separator (18) electrically insulated from the cathode (24) and facing the surface of the cathode (24) that is opposite to the surface of the cathode (24) facing the electrolyte membrane (20), and the second conductive member (42) connected to the cathode (24), passing through the second separator (18) while being electrically insulated from the second separator (18), and exposed on the surface of the second separator (18) other than the surface facing the cathode (24).

According to the present invention, the first separator and the second separator are in an electrically floating state. Therefore, even if water reaches the separator (the first or second separator) formed of metal, corrosion of the separator due to water-mediated electrochemical reactions can be suppressed. As a result, dielectric breakdown of the insulating film members of the first separator electrically insulated from the anode and the second separator electrically insulated from the cathode is suppressed, and generated electric power can be stably output.

(2) In the fuel cell (10) according to the present invention, the first conductive member (40) may be exposed on the first surface (16F) of the first separator (16) opposite to the surface of the first separator (16) facing the anode (22), and the second conductive member (42) may be exposed on the second surface (18F) of the second separator (18) opposite to the surface of the second separator (18) facing the cathode (24). Accordingly, the generated electric power can be collected more easily than in the case where the conductive members are exposed from the side surfaces of the separators.

(3) The fuel cell (10) according to the present invention further includes the plurality of electrode tabs (44) for collecting the generated electric power, wherein one of the plurality of electrode tabs (44) may be joined to the first surface (16F) in the state of being connected to the first conductive member (40), and another one of the plurality of electrode tabs (44) may be joined to the second surface (18F) in the state of being connected to the second conductive member (42). This makes it easy to alternately stack the electrode tab and the unit cell including the electrolyte membrane, the anode, the cathode, the first separator, and the second separator.

Moreover, the present invention is not limited to the above-described disclosure, and various configurations can be adopted therein without departing from the essence and gist of the present invention.

1. A fuel cell comprising:
an anode divided into a plurality of anode portions,
a cathode divided into a plurality of cathode portions,
an electrolyte membrane arranged between the anode and the cathode, the electrolyte membrane being provided with a plurality of interconnectors, one of the interconnectors connecting one of the anode portions and one of the cathode portions,
a first separator electrically insulated from the anode and facing a surface of the anode that is opposite to a surface of the anode facing the electrolyte membrane,
a first conductive member connected to the anode, passing through the first separator while being electrically insulated from the first separator, and exposed on a surface of the first separator other than a surface facing the anode,
a second separator electrically insulated from the cathode and facing a surface of the cathode that is opposite to a surface of the cathode facing the electrolyte membrane, and
a second conductive member connected to the cathode, passing through the second separator while being electrically insulated from the second separator, and exposed on a surface of the second separator other than a surface facing the cathode.

2. The fuel cell according to claim 1, wherein
the first conductive member is exposed on a first surface of the first separator opposite to the surface of the first separator facing the anode, and
the second conductive member is exposed on a second surface of the second separator opposite to the surface of the second separator facing the cathode.

3. The fuel cell according to claim 2, further comprising:
a plurality of electrode tabs configured to collect generated electric power,
wherein one of the plurality of electrode tabs is joined to the first surface in a state of being connected to the first conductive member, and
wherein another one of the plurality of electrode tabs is joined to the second surface in a state of being connected to the second conductive member.
